(19) United States
(12) Patent Application Publication
(10) Pub. No.: US 2002/0085709 A1
(43) Pub. Date: Jul. 4, 2002

(54) Cover for portable phone

(76) Inventor: Gimmy Hsu, Chong Ho City (TW)

Correspondence Address: Gimmy Hsu, 6F, No. 440-2, Gin Pin Road, Chong Ho City, Taipei Hsien, 235, TW

(21) Appl. No.: 09/754,430

(22) Filed: Jan. 2, 2001

(51) Int. Cl. H04M 1/00

(52) U.S. Cl. 379/433.11; 379/447

(57) ABSTRACT

A cover for attaching onto a portable phone includes an outer housing made of titanium material for shielding electromagnetic waves, and includes a casing engaged in the housing and having a latch device for attaching and securing onto the portable phone. The casing includes one or more projections for engaging with the portable phone and includes a number of orifices and an opening aligned with the orifices and the opening of the housing for receiving the dialing buttons and the displayed window of the portable phone.

### BACKGROUND OF THE INVENTION

1. Field of the Invention

The present invention relates to a portable phone, and more particularly to a cover for the portable phone.

2. Description of the Prior Art

Typical portable phones comprise a cover made of plastic materials which may not be used for shielding the electromagnetic wave and which may include a porous structure formed therein. The other covers are made of magnesic materials which also may not be used for shielding the electromagnetic wave and which may also include a porous structure formed therein that may form an uneven or coarse outer peripheral surface to the portable phone.

The present invention has arisen to mitigate and/or obviate the afore-described disadvantages of the conventional portable phone covers.

### SUMMARY OF THE INVENTION

The primary objective of the present invention is to provide a cover for a portable phone having a characteristic for shielding the electromagnetic wave and for preventing the electromagnetic wave from hurting the users.

The other objective of the present invention is to provide a cover for a portable phone having a smooth outer appearance and having no porous structure formed therein.

In accordance with one aspect of the invention, there is provided a cover for attaching onto a portable phone body, the cover comprising an outer housing including a chamber formed therein, the outer housing being made of titanium material for shielding electromagnetic waves, and a casing engaged in the chamber of the housing and including a latch device extended therefrom for attaching onto the portable phone body.

The casing includes at least one projection extended therefrom for engaging with the portable phone body. The housing includes a plurality of orifices and an opening formed therein, the casing includes a plurality of orifices and an opening formed therein and aligned with the orifices and the opening of the housing.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a front perspective view of a portable phone having a cover in accordance with the present invention;

FIG. 2 is a rear perspective view of the cover;

FIG. 3 is an exploded view of the cover;

FIG. 4 is a cross sectional view taken along lines 4-4 of FIG. 2; and

FIG. 5 is an exploded view illustrating the other embodiment of the portable phone.

### DETAILED DESCRIPTION OF THE PREFERRED EMBODIMENT

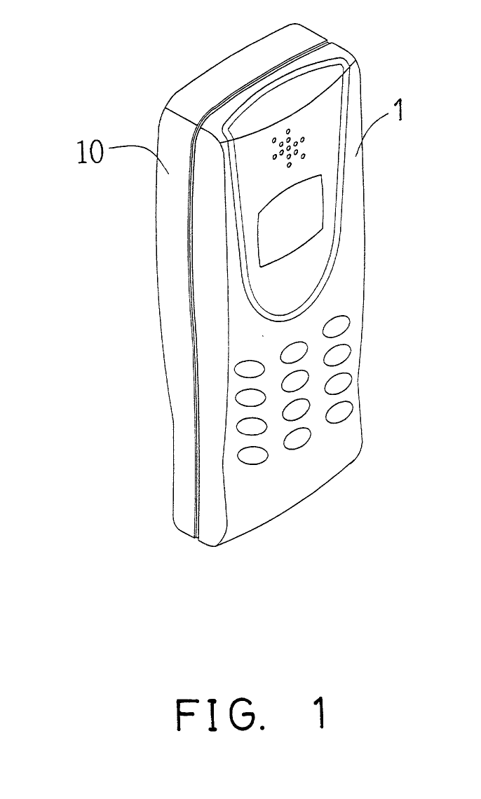

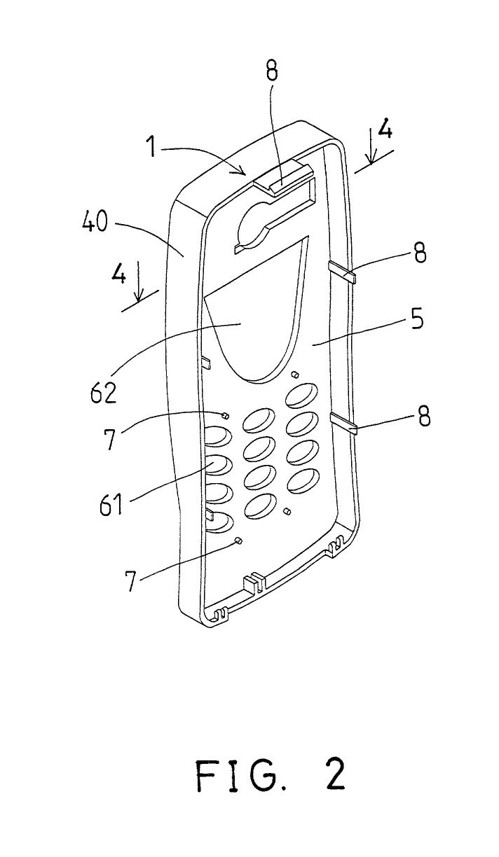

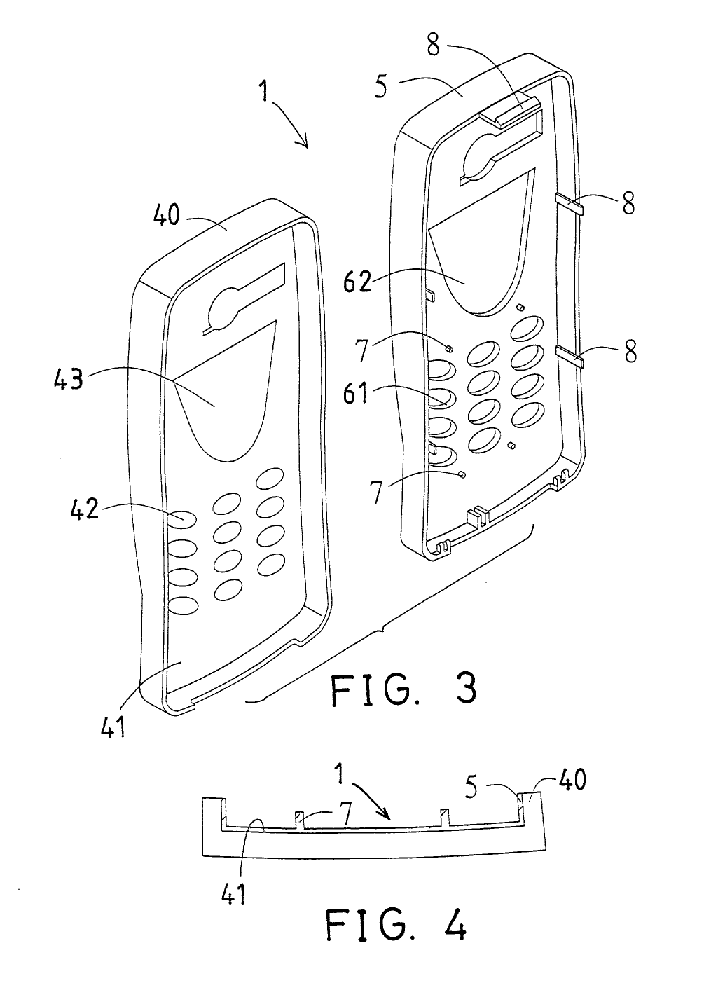

Referring to the drawings, and initially to FIG. 1, a cover 1 in accordance with the present invention is provided for attaching or for securing onto the portable phone body 10. As shown in FIGS. 2-4, the cover 1 comprises an outer housing 40 made of titanium material that may be forged and machined to form a smooth outer surface and having no porous structure or air holes formed therein. The outer housing 40 includes a chamber 41 formed therein for receiving a casing 5 and includes a number of orifices 42 and an opening 43 formed therein.

The casing 5 is engaged in the chamber 41 of the outer housing 40 and may be made of plastic material or the like, and includes a number of orifices 61 and an opening 62 formed therein and aligned with the orifices 42 and the opening 43 of the outer housing 40 for receiving the dial buttons of the portable phone body 10 and for aligning with the displayed window of the portable phone body 10 respectively. The casing 5 includes one or more projections 7 extended therefrom for engaging with the portable phone body 10 and includes one or more latches 8 extended therefrom for hooking or securing the cover 1 onto the portable phone body 10. The projections 7 and the latches 8 may be easily formed on the casing 5 when the casing 5 is formed by such as the molding processes or the mold injection processes.

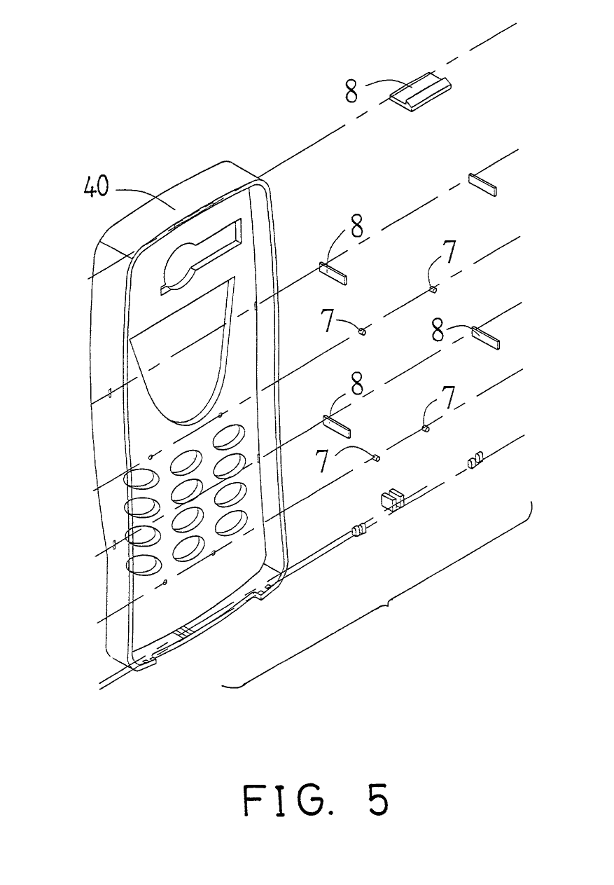

Referring next to FIG. 5, the projections 7 and the latches 8 may also be formed separately and then secured onto the housing 40 with such as the adhesive materials, or by welding processes.

It is to be noted that the outer housing 40 is made of titanium material and may be used for shielding the electromagnetic wave and for preventing the electromagnetic wave from hurting the users and may be formed into a smooth outer appearance having no porous structure formed therein. The provision and the formation of the casing 5 in the housing 40 may be easily formed by the molding processes or by the mold injection processes. The casing 5 may have the projections 7 and the latches 8 easily and quickly formed thereon.

Accordingly, the portable phone in accordance with the present invention includes a cover that may be used for shielding the electromagnetic wave and for preventing the electromagnetic wave from hurting the users and that includes a smooth outer appearance having no porous structure formed therein.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cover for attaching onto a portable phone body, said cover comprising:
an outer housing including a chamber formed therein, said outer housing being made of titanium material for shielding electromagnetic waves, and
a casing engaged in said chamber of said housing and including a latch device extended therefrom for attaching onto the portable phone body.

2. The portable phone according to claim 1,
wherein said casing includes at least one projection extended therefrom for engaging with the portable phone body.

3. The portable phone according to claim 1,
wherein said housing includes a plurality of orifices and an opening formed therein, said casing includes a plurality of orifices and an opening formed therein and aligned with said orifices and said opening of said housing.
